(19) United States
(12) Patent Application Publication
(10) Pub. No.: US 2024/0370717 A1
(43) Pub. Date: Nov. 7, 2024

(54) CROSS-PLATFORM DISTILLATION FRAMEWORK

(71) Applicant: Google LLC, Mountain View, CA (US)

(72) Inventors: Qifei Wang, Sunnyvale, CA (US); Yicheng Fan, Santa Clara, CA (US); Wei Xu, Santa Clara, CA (US); Jiayu Ye, Mountain View, CA (US); Lu Wang, Redwood City, CA (US); Chuo-Ling Chang, Mountain View, CA (US); Dana Alon, Mountain View, CA (US); Erik Nathan Vee, Hillsborough, CA (US); Hongkun Yu, Redwood City, CA (US); Matthias Grundmann, Mountain View, CA (US); Shanmugasundaram Ravikumar, Piedmont, CA (US); Andrew Stephen Tomkins, Menlo Park, CA (US)

(73) Assignee: Google LLC, Mountain View, CA (US)

(21) Appl. No.: 18/313,189

(22) Filed: May 5, 2023

(51) Int. Cl. G06N 3/08

(52) U.S. Cl. CPC G06N 3/08

(57) ABSTRACT

A method for a cross-platform distillation framework includes obtaining a plurality of training samples. The method includes generating, using a student neural network model executing on a first processing unit, a first output based on a first training sample. The method also includes generating, using a teacher neural network model executing on a second processing unit, a second output based on the first training sample. The method includes determining, based on the first output and the second output, a first loss. The method further includes adjusting, based on the first loss, one or more parameters of the student neural network model. The method includes repeating the above steps for each training sample of the plurality of training samples.

### TECHNICAL FIELD

This disclosure relates to a cross-platform distillation framework.

### BACKGROUND

In machine learning, training a model is a time and resource intensive process, especially as models typically perform better when they are trained on large data sets. However, there are drawbacks with using large models (i.e., models trained on large data sets), such as inflexibility and difficulty in deploying large models on smaller devices. Smaller models, which are easier to deploy, can be used for specific contexts (i.e., trained on context-specific data). However, such smaller models may not perform as well as large models, as the training process is less robust. Knowledge distillation is the process of transferring the knowledge from a generally larger trained model (i.e., a “teacher model”) to a generally smaller model (i.e., a “student model”) such that the smaller model can perform without significant loss of performance compared to the large model, while still maintaining the benefits of a smaller model.

### SUMMARY

One aspect of the disclosure provides for a computer-implemented method for a cross-platform distillation framework. The computer-implemented method when executed by data processing hardware causes the data processing hardware to perform operations including obtaining a plurality of training samples. The operations include generating, using a student neural network model executing on a first processing unit, a first output based on a first training sample of the plurality of training samples. The operations further include generating, using a teacher neural network model executing on a second processing unit, a second output based on the first training sample of the plurality of training samples, the second processing unit remote from the first processing unit. The operations include determining, based on the first output and the second output, a first loss. The operations also include adjusting, based on the first loss, one or more parameters of the student neural network model. The operations include after adjusting the one or more parameters of the student neural network model, generating, using the student neural network model, a third output based on a second training sample of the plurality of training samples. The operations include generating, using the teacher neural network model, a fourth output based on the second training sample of the plurality of training samples. The operations further include determining, based on the third output and the fourth output, a second loss. The operations include readjusting, based on the second loss, the one or more parameters of the student neural network model.

Implementations of the disclosure may include one or more of the following optional features. In some implementations, the first processing unit and the second processing unit each include a respective tensor processing unit. The operations may further include transmitting a remote procedure call (RPC) to the teacher neural network model to generate each output. Further, the first output, the second output, the third output, and the fourth output may each include a respective logit.

In some implementations, the operations further include determining, based on the loss, a gradient and adjusting one or more parameters of the student neural network model by applying the gradient to the student neural network model. The teacher neural network model may include a trained model. In some implementations, the first processing unit belongs to a first entity and the second processing unit belongs to a second entity different from the first entity.

In some implementations, the first training sample includes an unlabeled training sample. In these implementations, the operations may further include generating, based on the second output from the teacher neural network model, a label for the first training sample. In these implementations, the operations may further include generating, using a second student neural network model executing on a third processing unit, a fifth output based on the labeled first training sample, determining, based on the label and the fifth output, a third loss, and adjusting, based on the third loss, the second student neural network model.

Another aspect of the disclosure provides a system for a cross-platform distillation framework. The system includes data processing hardware and memory hardware in communication with the data processing hardware. The memory hardware stores instructions that when executed on the data processing hardware cause the data processing hardware to perform operations. The operations include generating, using a student neural network model executing on a first processing unit, a first output based on a first training sample of the plurality of training samples. The operations further include generating, using a teacher neural network model executing on a second processing unit, a second output based on the first training sample of the plurality of training samples, the second processing unit remote from the first processing unit. The operations include determining, based on the first output and the second output, a first loss. The operations also include adjusting, based on the first loss, one or more parameters of the student neural network model. The operations include after adjusting the one or more parameters of the student neural network model, generating, using the student neural network model, a third output based on a second training sample of the plurality of training samples. The operations include generating, using the teacher neural network model, a fourth output based on the second training sample of the plurality of training samples. The operations further include determining, based on the third output and the fourth output, a second loss. The operations include readjusting, based on the second loss, the one or more parameters of the student neural network model.

This aspect may include one or more of the following optional features. In some implementations, the first processing unit and the second processing unit each include a respective tensor processing unit. The operations may further include transmitting a remote procedure call (RPC) to the teacher neural network model to generate each output. Further, the first output, the second output, the third output, and the fourth output may each include a respective logit.

In some implementations, the operations further include determining, based on the loss, a gradient and adjusting one or more parameters of the student neural network model by applying the gradient to the student neural network model. The teacher neural network model may include a trained model. In some implementations, the first processing unit belongs to a first entity and the second processing unit belongs to a second entity different from the first entity.

In some implementations, the first training sample includes an unlabeled training sample. In these implementations, the operations may further include generating, based on the second output from the teacher neural network model, a label for the first training sample. In these implementations, the operations may further include generating, using a second student neural network model executing on a third processing unit, a fifth output based on the labeled first training sample, determining, based on the label and the fifth output, a third loss, and adjusting, based on the third loss, the second student neural network model.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for a cross-platform distillation framework.

FIG. 2 is a schematic view of an example cross-platform distillation training process.

FIG. 3 is a schematic view of another example cross-platform distillation training process.

FIG. 4 is a schematic view of a sequence diagram for a cross-platform distillation framework.

FIG. 5 a flowchart of an example arrangement of operations for a method of a cross-platform distillation framework.

FIG. 6 is a schematic view of an example computing device that may be used to implement the systems and methods described herein.

Like reference symbols in the various drawings indicate like elements.

### DETAILED DESCRIPTION

Distillation is the process of transferring knowledge from a teacher model (e.g., a large trained model) to a student model (e.g., a smaller untrained model) during training of the student model. Distillation provides for the student model to be trained more quickly (and on less training data) than the teacher model while maintaining performance that is substantially the same as the teacher model. One distillation technique, known as online distillation, includes feeding a training sample to both the teacher model and the student model, obtaining a respective output based on the training sample from each of the teacher model and the student model, determining a loss from a combination of the teacher output and the student output, and adjusting the student model based on the loss. Current techniques for online distillation require the teacher model and the student model to be hosted on the same platform/framework (e.g., the same processor).

Another distillation technique, known as offline distillation, includes labeling a set of training data using the teacher model, and then training the student model using the teacher-labeled training data. In offline distillation, the teacher model and the student model can be stored in different frameworks. However, offline distillation requires the storage, and transfer, of the teacher-labeled set of training data, which can be prohibitively large, making offline distillation not scalable.

Implementations herein are directed to a cross-platform distillation framework. In particular, the distillation techniques of the current disclosure allow for a teacher model stored on or using a first framework to transfer knowledge to a student model stored on or using a second framework during training of the student model. A training module may transmit training samples to each of the teacher model and the student model. In some implementations, the training module transmits the training samples to the teacher model through a remote procedure call (RPC). The student model may then generate a first output based on the training sample and the teacher model may generate a second output based on the training sample. The training module may then generate a loss based on the first output and the second output. In some implementations, the training module adjusts one or more parameters of the student model based on the loss. The training module may repeat these steps for each training sample in the plurality of training samples.

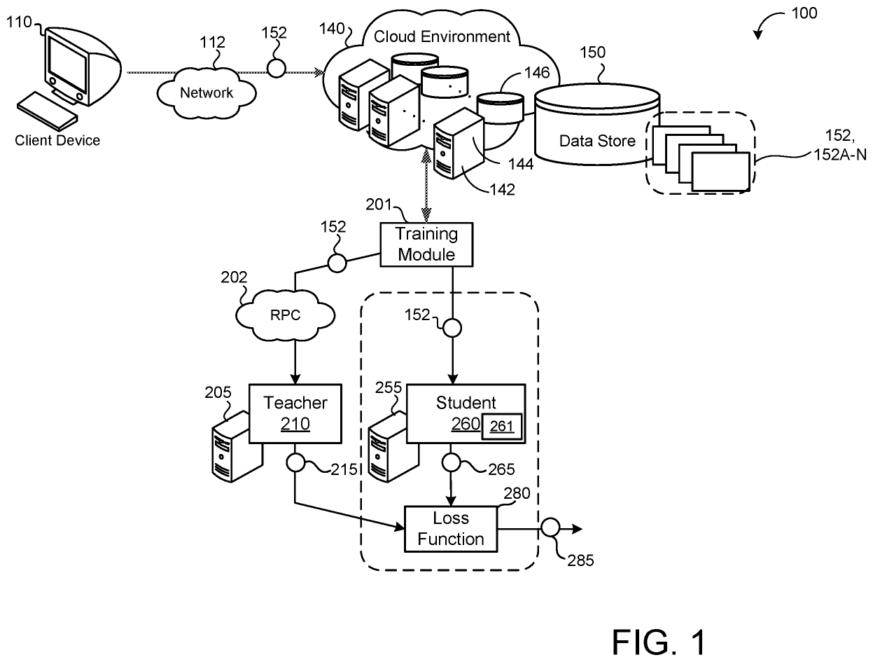

Referring to FIG. 1, in some implementations, an example cross-platform distillation system 100 includes a cloud environment 140 in communication with one or more user devices 110 via a network 112. The cloud environment 140 may be a single computer, multiple computers, or a distributed system having scalable/elastic resources 142 including computing resources 144 (e.g., data processing hardware) and/or storage resources 146 (e.g., memory hardware). The cloud environment 140 may be configured to store a large amount of data for use in big data analytics. A data store 150 (i.e., a remote storage device) may be overlain on the storage resources 146 to allow scalable use of the storage resources 146 by one or more of the clients (e.g., the user device 10) or the computing resources 144. The data store 150 is configured to store a plurality of training samples 152, 152A-N associated with a set of training data 152.

The cloud environment 140 is configured to obtain the training samples 152 of the plurality of training samples 152 for a training module 201 from, for example, a user device 110 via the network 112. For example, if the training module 201 is configured to train one or more neural network models for speech recognition, the training samples 152 may be a recording of an utterance (i.e., snippet of speech) of the user using the client device 110. In some implementations, the training samples 152 may be labeled. In these implementations, the training samples 152 may include an utterance with a ground truth transcription of the utterance. The user device 110 may correspond to any computing device, such as a desktop workstation, a laptop workstation, or a mobile device (i.e., a smart phone). The user device 110 includes computing resources (e.g., data processing hardware) and/or storage resources (e.g., memory hardware).

The cloud environment 140 executes the training module 201 for performing cross-platform distillation using a teacher neural network model 210 (also referred to herein as just the teacher 210) executing on a first platform 205 and a student neural network model 260 (also referred to herein as just the student 260) executing on a second platform 255. The student 260 includes one or more parameters 261 (e.g., weights or the like). Here, the teacher 210 may be a trained model that the training module 201 is configured to implement in a cross-platform distillation training process to transfer knowledge from the teacher 210 to one or more students 260 during training of the student(s) 260. As used herein, the term “platform” can refer to any suitable computing environment for executing a neural network model and/or a machine learning model, such as a processing unit of a computer and/or a framework (such as tensorflow, jax, pytorch, MXNet, etc.). In some implementations the first platform 205 is a first processor (e.g., a first tensor processing unit (TPU)) and the second platform 255 is a second processor (e.g., a second TPU) different from the first processor. The first processor and second processor may belong a group of computers in a computing environment (e.g., cloud environment 140). In additional implementations, the first platform 205 is a first framework and the second platform 255 is a second framework. In these implementations, the teacher 210 is a model trained and inferred on the first framework and the student is trained in the second framework. Alternatively, the first processor and second processor may belong to distinct entities. For example, the first processor may belong to a server environment (i.e., cloud environment 140) capable of storing and hosting a large trained neural network model (i.e., teacher 210) while the second processor belongs to a device (i.e., client device 110) with less processing power and less memory that is configured to deploy and train a smaller neural network model (i.e., student 260). In this example, the second processor can train the smaller neural network model through distillation without having access to the large trained neural network model. Or put another way, the owner of the teacher 210 may allow training of one or more students 260 without having to allow access to the teacher 210 (e.g., for security or proprietary purposes).

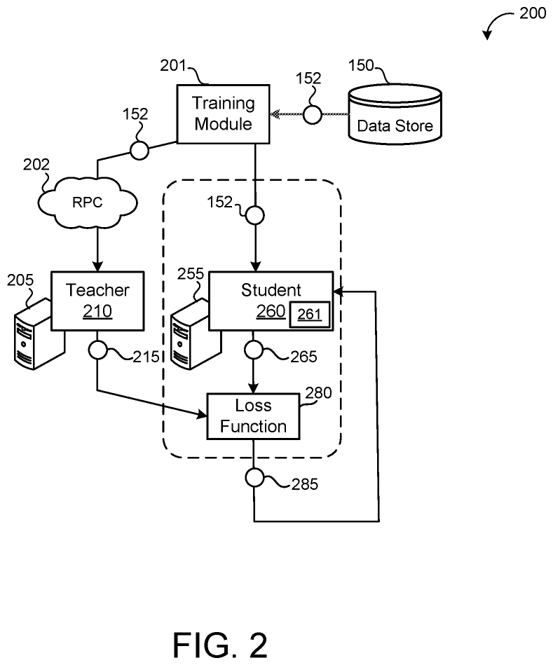

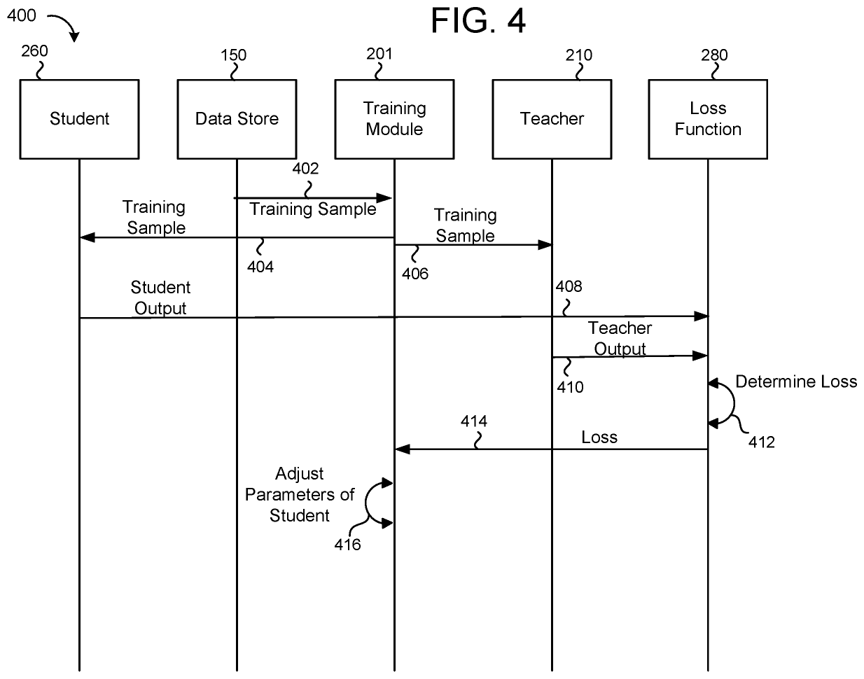

The training module 201 is configured to obtain training samples 152 (e.g., from the user device 110, the data store 150, remote servers, or other modules of the cloud environment 140). The training module 201, in some implementations, transmits one or more training samples 152 of the plurality of training samples 152 to each of the teacher 210 and the student 260. The training module 201 may transmit the training sample 152 to the teacher 210 via a remote procedure call (RPC) 202. The training module may then obtain respective outputs 215, 265 from the teacher 210 and student 260. In some implementations the training module 201 may implement a loss function 280 to determine a loss 285 based on the outputs 215, 265 (i.e., a representative of a difference between the outputs 215, 265). The distillation process of the training module 201 is discussed in greater detail below (FIG. 2 and FIG. 4).

The system of FIG. 1 is presented for illustrative purposes only and is not intended to be limiting. For example, although only a single example of each component is illustrated, the system 100 may include any number of components 110, 112, 140, 150, 201, 205, 210, 255, 260, and 280. Further, although some components are described as being located in a cloud computing environment 140, in some implementations, some or all of the components may be hosted locally on the client device 110. Further, in various implementations, some or all of the components, are hosted locally on user device 110, remotely (such as in the cloud computing environment 140), or any combination thereof.

FIG. 2 illustrates a schematic view 200 of an example cross-platform distillation training process. Here, the training module 201 is configured to perform the cross-platform distillation. The training process may begin when the training module 201 obtains a first training sample 152 from a data store 150. The training sample 152 may belong to a set and/or a plurality of training samples 152 stored at the data store 150. The training sample 152 may be based on the type of neural network models that are being trained by the training module 201 in the cross-platform distillation training process. For example, when the neural network models are adapted for speech recognition, the training samples 152 include speech samples, such as utterances recorded at a client device. In another example, when the neural network models are adapted for natural language processing, the training samples 152 are transcripts of text. In yet other examples, the training samples 152 may include images.

Once the training module 201 obtains the first training sample 152, the training module may then transmit the training sample 152 to each of a student neural network model 260 and a teacher neural network model 210. In some implementations, the training module 201 transmits the training sample 152 as a remote procedure call (RPC) 202, causing the teacher 210, via teacher platform 205, to generate a teacher output 215 based on the training sample 152. In some implementations, the teacher platform 205 of the teacher 210 is different than the student platform 255 of the student 260. For example, the teacher platform 205 of the teacher 210 is a processor unit, such as a tensor processing unit running on a first computer, and the student platform 255 of the student 260 is a different processing unit, such as a different tensor processing unit running on a second computer. In some implementations, the teacher 210 and student 260 execute on respective platforms 205, 255 that are in a shared computer network, such as two computers in a cloud computing environment (e.g., cloud environment 140). In other implementations, the teacher 210 and student 260 execute on respective platforms 205, 255 that are in a remote computer networks. For example, the teacher 210 executes in a teacher platform 205 belonging to a first entity (e.g., a server of an organization or business), while the student 260 executes in a student platform 255 belonging to a second entity (e.g., a client device of a customer of the organization) adapted to communicate with the first entity (e.g., via one or more networks). The platforms 205, 255 can be any suitable platform and/or processing unit for executing a neural network model such as a tensor processing unit, a graphics processing unit, a computer processing unit, etc.

The teacher 210 and the student 260 may each generate a respective output 215, 265 based on the first training sample 152. The outputs 215, 265 may be in any suitable form of an output of a neural network model and/or machine learning model such as a logit, a probability density function, a sigmoid function, etc. The training module 201 may then obtain the respective outputs 215, 265 from the teacher 210 and the student 260. The training module may then implement a loss function 280 to determine a loss 285 based on the outputs 215, 265. In some implementations, the teacher 210 and the student 260 may run in parallel (e.g., synchronously) to produce outputs 215, 265 at the same time or nearly the same time. Accordingly, the loss function 280 obtains the outputs 215, 265 at the same time or nearly the same time to generate the loss 285. During such synchronous cross-distillation, student 260 is generally adjusted based on the loss 280 for a set of outputs 215, 265 prior to the next set of outputs 215, 265 being generated (i.e., the teacher 210 generates outputs 215 synchronously with the outputs 265 of the student 260). In other implementations, the teacher 210 and the student 260 execute asynchronously (i.e., the teacher 210 may generate outputs 215 independent of the student 260 generating outputs 265). In these implementations, the loss function 280 may not generate a loss 285 until the respective pair of outputs 215, 265 generated based on the first training sample 152 is received. The loss function 280 may execute on the student platform 255. Alternatively, the loss function 280 executes in a separate environment remote from either platform 205, 255.

The training module 201 may adjust the one or more parameters 261 (e.g., weights) of the student 260 based on the loss 285. In some implementations, the training module 201 generates a gradient based on the loss 285. The training module 201 may adjust the one or more parameters 261 of the student 260 by applying the gradient to the student 260. Once the training module 201 adjusts the one or more parameters 261 of the student based on the loss 285, the training module 201 may restart the cross-platform distillation training process with a second training sample 152. The training module 201 can continue the cross-platform distillation training process for each training sample 152 of the set of training samples 152. In some implementations, the training module 201 does not transmit the next training sample 152 until the process has been completed for the current training sample 152. In other words, the training module 201 executes the cross-platform distillation training process sequentially or synchronously for each training sample 152 of the set of training samples 152 such that training module 201 completes the training process for each training sample 152 (i.e., generates outputs 215, 265, calculates a loss 285, and adjusts one or more parameters of the student 260 based on the loss 285) before continuing with the next training sample 152.

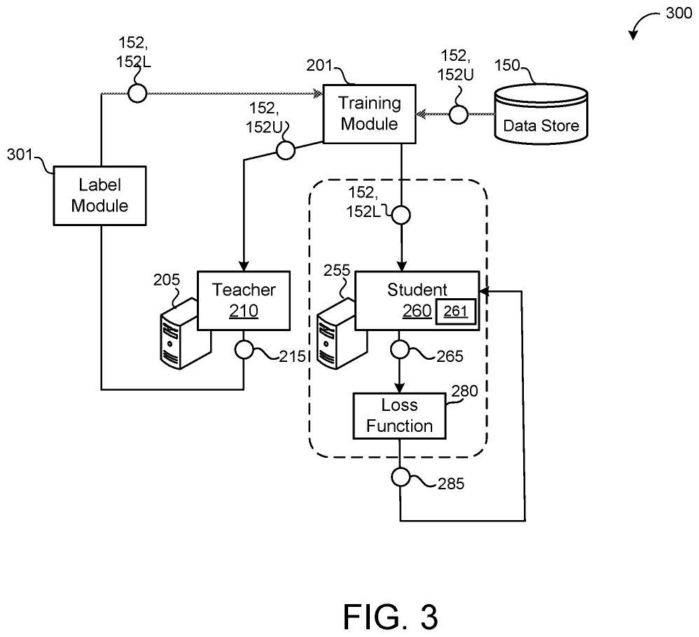

FIG. 3 is a schematic view 300 of another example cross-platform distillation training process. Here, the training module 201 may be configured to obtain a labeled training sample 152, 152L from a teacher neural network model 210 executing on a teacher platform 205 based on an unlabeled training sample 152, 152U. In some implementations, the training module 201 transmits the unlabeled training sample 152U as a remote procedure call (RPC), causing the teacher 210, via teacher platform 205, to generate a teacher output 215 based on the unlabeled training sample 152U. The teacher output 215 may be any suitable output from a neural network model and/or a machine learning model, such as a logit. The training module 201 may implement a label module 301 to generate the labeled training sample 152L based on the teacher output 215 of the teacher 210 and the unlabeled training sample 152U. In some implementations, the labeled training sample 152L merely includes the unlabeled training sample 152U with the teacher output 215 as the label. In other implementations, the label module 301 modifies or adjusts the teacher output 215 to an appropriate label for machine learning/neural network training using a labeled training sample 152L.

The training module 201 may then transmit the labeled training sample 152L to a student neural network model 260 executing on a student platform 255. The student 260 may generate a student output 265 based on the labeled training sample 152L. The student output 265 may be in any suitable form as an output from a neural network model and/or machine learning model, such as a logit. The training module 201 may implement a loss function 280 to determine a loss 285 based on the student output 265 and the labeled training sample 152L. For example, the loss function 280 may compare the label of the labeled training sample 152L to the student output 265 to determine the loss 285. The training module 201 may then adjust one or more parameters of the student 260 based on the loss 285.

In some implementations, the training module 201 executes sequentially for each unlabeled training sample 152U, 152 from a plurality of unlabeled training samples 152U. In other words, the training module 201 may transmit a first unlabeled training sample 152U to the teacher 210 to obtain a first labeled training sample 152L (based on a first teacher output 215 based on the first unlabeled training sample 152U) from the label module 301. The training module 201 may then transmit the first labeled training sample to the student 260 such that the student 260 generates a first student output 265. The training module 201 may then determine a first loss 285, via loss function 280, based on the student output 265 and the first labeled training sample 152L. The training module 201 may then adjust one or more parameters of the student 260 based on the loss 285. In some implementations, the training module 201 generates a gradient based on the loss 285. The training module 201 may then adjust the one or more parameters of the student 260 by applying the gradient to the student 260.

After the training module 201 adjusts one or more parameters of the student 260 based on the first loss 285, the training module 201 may then restart the training process with a second unlabeled training sample 152U from the plurality of training samples 152U. In this manner, the labeled training samples 152L are not stored in memory for an extended period of time. Instead, the labeled training samples 152L are used to train the student 260 once they are generated.

In some implementations, the training module 201 may be adapted to store a number of labeled training samples 152L until the student 260 is ready to process the labeled training samples 152L. In these implementations, the training module 201 may store the labeled training samples 152L at a memory that is convenient for the training process. For example, the training module 201 can store the labeled training samples 152L in a memory of the student platform 255. Alternatively, the training module 201 can store the labeled training samples 152L in a memory of a cloud computing network that has a large amount of free capacity.

As described above with relation to FIG. 2, the teacher platform 205 of the teacher 210 may be different from the student platform 255 of the student 260. For example, the teacher platform 205 of the teacher 210 is a processor unit, such as a tensor processing unit running on a first computer, and the student platform 255 of the student 260 is a different processing unit, such as a different tensor processing unit running on a second computer. In some implementations, the teacher 210 and student 260 execute on respective platforms 205, 255 that are in a shared computer network, such as two separate computers in a cloud computing environment (e.g., cloud environment 140). In other implementations, the teacher 210 and student 260 execute on respective platforms 205, 255 that are in a remote computer networks. For example, the teacher 210 executes in a teacher platform 205 belonging to a first entity (e.g., a server), while the student 260 executes in a student platform 255 belonging to a second entity (e.g., a client device) adapted to communicate with the first entity. The platforms 205, 255 can be any suitable platform and/or processing unit for executing a neural network model such as a tensor processing unit, a graphics processing unit, a computer processing unit, etc.

FIG. 4 is a schematic view of a sequence diagram 400 for a cross-platform distillation framework. The sequence begins at step 402 when a training module 201 obtains a training sample (e.g., training sample 152) from a data store 150. At step 404 and 406, the training module 201 transmits the training sample 152 to a student neural network model (“student”) 260 and a teacher neural network model (“teacher”) 210, respectively. The teacher 210 and student 260 may reside in separate platforms and/or processing units. In some implementations, the teacher 210 is a trained neural network model. The training module 201 may be adapted to transfer knowledge from the teacher 210 to the student 260 through the process of cross-platform distillation training. The teacher 210 and student 260 may be any suitable neural network model and/or machine learning model. The student 260 may be a smaller model that may be easier to deploy on a device such as a smart phone or personal computer with limited computational resources while the teacher 210 may be a large trained model that executes on a server. In some implementations, the teacher 210 and student 260 are the same type of neural network/model. For example, the teacher 210 may be trained neural network adapted for speech recognition and the student 260 is an untrained neural network configured to be deployed on a client device and adapted for local speech recognition on the client device. Further, the teacher 210 and student 260 may be any neural networks and/or models that are suitable for learning through distillation, such as computer vision, natural language processing, speech recognition, etc. Steps 404 and 406 may occur simultaneously or nearly simultaneously.

At step 408, the student 260 may transmit a student output (e.g., student output 265) to a loss function 280. At step 410, the teacher 210 may transmit a teacher output (e.g., teacher output 215) to the loss function 280. The student output 265 and the teacher output 215 may be of any suitable type of output from a neural network model and/or machine learning model, such as a logit. In some implementations, the teacher 210 and the student 260 operate in parallel (i.e., synchronously) such that the loss function 280 obtains the teacher output 215 and the student output 265 at the same time or near the same time. In alternative implementations, the student 260 and the teacher 210 may operate asynchronously. In these alternative implementations, the loss function may be adapted to store either output 215, 265 until the corresponding output 265, 215 is received before determining the respective loss (step 412) based on the outputs 215, 265 associated with the training sample 152. In some implementations, the loss function 280 is a component of the training module 201. Further, the training module 201 and the loss function 280 may execute in the same platform as the student 260. Alternatively, the training module 201 and the loss function 280 may execute in a different platform than the student 260 and/or the teacher 210. At step 412 the loss function 280 may determine a loss (e.g., loss 285) based on the outputs 215, 265.

At step 414, the training module 201 may obtain the loss 285. At step 416, the training module 201 may adjust one or more parameters 261 of the student 260. In some implementations, the training module 201 generates a gradient based on the loss 285. The training module 201 may then adjust the one or more parameters of the student 260 by applying the gradient to the student 260. The cross-platform distillation training process may iterate through each training sample 152 of a set of training samples (e.g., plurality of training samples 152) to complete training of the student 260.

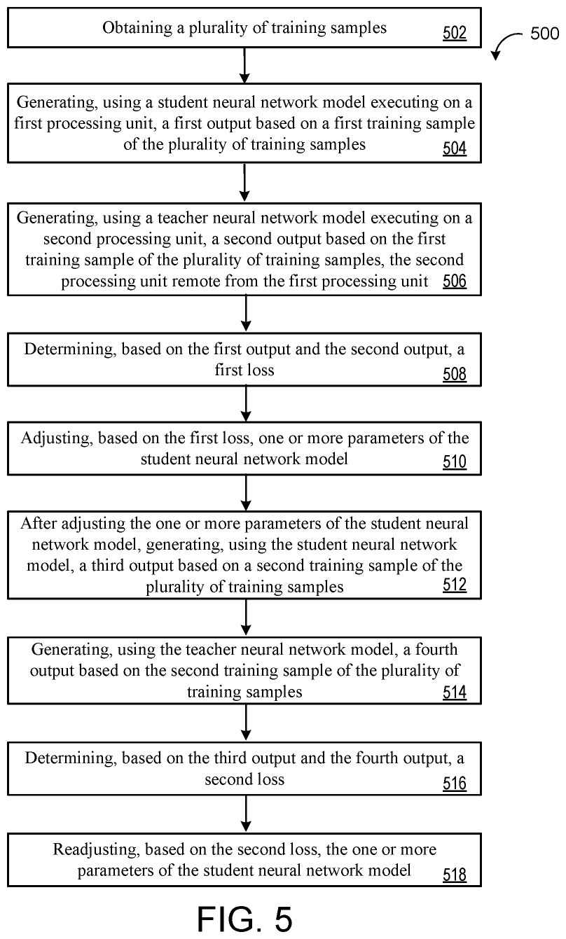

FIG. 5 is a flowchart of an exemplary arrangement of operations for a method 500 of a cross-platform distillation framework. The method 500 may be performed, for example, by various elements of the cross-platform distillation system 100 of FIG. 1. At operation 502, the method 500 includes obtaining a plurality of training samples 152. At operation 504, the method 500 includes generating, using a student neural network model 260 executing on a first processing unit 255, a first output 265 based on a first training sample 152 of the plurality of training samples 152. At operation 506, the method 500 includes generating, using a teacher neural network model 210 executing on a second processing unit 205, a second output 215 based on the first training sample 152 of the plurality of training samples 152, the second processing unit 205 remote from the first processing unit 255. At operation 508, the method 500 includes determining, based on the first output 265 and the second output 215, a first loss 285. At operation 510, the method 500 includes adjusting, based on the first loss 285, one or more parameters 161 of the student neural network model 260. At operation 512, the method 500 includes, after adjusting the one or more parameters 161 of the student neural network model 260, generating, using the student neural network model 260, a third output 265 based on a second training sample 152 of the plurality of training samples 152. At operation 514, the method 500 includes generating, using the teacher neural network model 210, a fourth output 215 based on the second training sample 152 of the plurality of training samples 152. At operation 516, the method 500 includes determining, based on the third output 265 and the fourth output 215, a second loss 285. At operation 518, the method 500 includes readjusting, based on the second loss 285, the one or more parameters of the student neural network model 260.

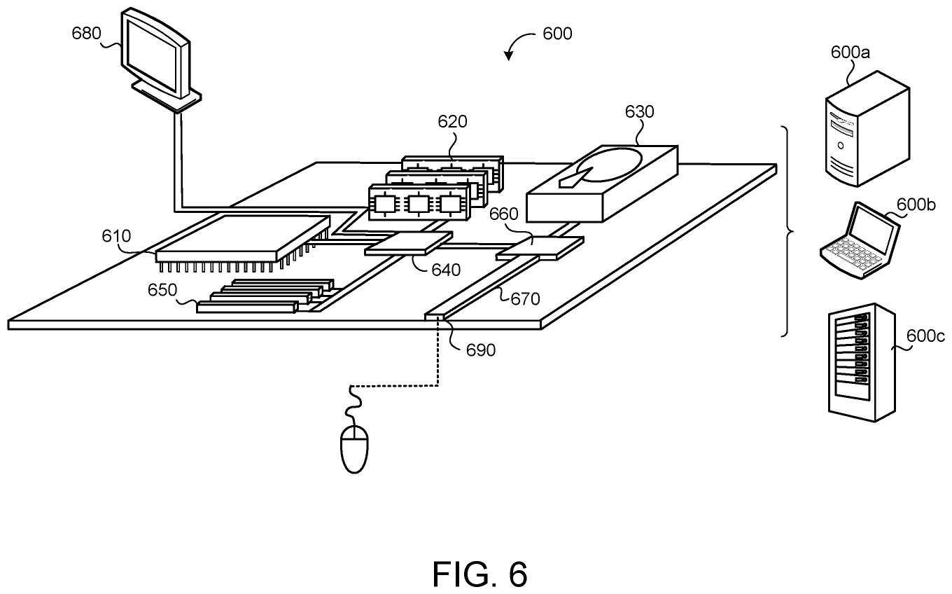

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
obtaining a plurality of training samples;
generating, using a student neural network model executing on a first processing unit, a first output based on a first training sample of the plurality of training samples;
generating, using a teacher neural network model executing on a second processing unit, a second output based on the first training sample of the plurality of training samples, the second processing unit remote from the first processing unit;
determining, based on the first output and the second output, a first loss;
adjusting, based on the first loss, one or more parameters of the student neural network model;
after adjusting the one or more parameters of the student neural network model, generating, using the student neural network model, a third output based on a second training sample of the plurality of training samples;
generating, using the teacher neural network model, a fourth output based on the second training sample of the plurality of training samples;
determining, based on the third output and the fourth output, a second loss; and
readjusting, based on the second loss, the one or more parameters of the student neural network model.

2. The method of claim 1, wherein the first processing unit and the second processing unit each comprise a respective tensor processing unit.

3. The method of claim 1, wherein the operations further comprise transmitting a remote procedure call (RPC) to the teacher neural network model to generate each output.

4. The method of claim 1, wherein the first output, the second output, the third output, and the fourth output each comprise a respective logit.

5. The method of claim 1, wherein adjusting the one or more parameters of the student neural network model comprises determining, based on the first loss, a gradient.

6. The method of claim 1, wherein the teacher neural network model comprises a trained model.

7. The method of claim 1, wherein the first processing unit belongs to a first entity and the second processing unit belongs to a second entity different from the first entity.

8. The method of claim 1, wherein the first training sample comprises an unlabeled training sample.

9. The method of claim 8, wherein the operations further comprise generating, based on the second output from the teacher neural network model, a label for the first training sample.

10. The method of claim 9, wherein the operations further comprise:
generating, using a second student neural network model executing on a third processing unit, a fifth output based on the labeled first training sample;
determining, based on the label and the fifth output, a third loss; and
adjusting, based on the third loss, the second student neural network model.

11. A system comprising:
data processing hardware; and
memory hardware in communication with the data processing hardware, the memory hardware storing instructions that when executed on the data processing hardware cause the data processing hardware to perform operations comprising:
obtaining a plurality of training samples;
generating, using a student neural network model executing on a first processing unit, a first output based on a first training sample of the plurality of training samples;
generating, using a teacher neural network model executing on a second processing unit, a second output based on the first training sample of the plurality of training samples, the second processing unit remote from the first processing unit;
determining, based on the first output and the second output, a first loss;
adjusting, based on the first loss, one or more parameters of the student neural network model;
after adjusting the one or more parameters of the student neural network model, generating, using the student neural network model, a third output based on a second training sample of the plurality of training samples;
generating, using the teacher neural network model, a fourth output based on the second training sample of the plurality of training samples;
determining, based on the third output and the fourth output, a second loss; and
readjusting, based on the second loss, the one or more parameters of the student neural network model.

12. The system of claim 11, wherein the first processing unit and the second processing unit each comprise a respective tensor processing unit.

13. The system of claim 11, wherein the operations further comprise transmitting a remote procedure call (RPC) to the teacher neural network model to generate each output.

14. The system of claim 11, wherein the first output, the second output, the third output, and the fourth output each comprise a respective logit.

15. The system of claim 11, wherein adjusting the one or more parameters of the student neural network model comprises determining, based on the first loss, a gradient.

16. The system of claim 11, wherein the teacher neural network model comprises a trained model.

17. The system of claim 11, wherein the first processing unit belongs to a first entity and the second processing unit belongs to a second entity different from the first entity.

18. The system of claim 11, wherein the first training sample comprises an unlabeled training sample.

19. The system of claim 18, wherein the operations further comprise generating, based on the second output from the teacher neural network model, a label for the first training sample.

20. The system of claim 19, wherein the operations further comprise:
generating, using a second student neural network model executing on a third processing unit, a fifth output based on the labeled first training sample;
determining, based on the label and the fifth output, a third loss; and
adjusting, based on the third loss, the second student neural network model.
